(19) United States
(12) Patent Application Publication
(10) Pub. No.: US 2015/0053239 A1
(43) Pub. Date: Feb. 26, 2015

(54) WAFER CARRIER CLEANING METHOD

(71) Applicant: KABUSHIKI KAISHA TOSHIBA, Tokyo (JP)

(72) Inventors: Yasushige ABE, Oita (JP); Hidekazu TANIGUCHI, Oita (JP); Masanobu KIBE, Oita (JP); Kosuke MIYAMOTO, Oita (JP)

(73) Assignee: KABUSHIKI KAISHA TOSHIBA, Tokyo (JP)

(21) Appl. No.: 14/194,618

(22) Filed: Feb. 28, 2014

(30) Foreign Application Priority Data
Aug. 23, 2013 (JP) 2013-173913

(51) Int. Cl. B08B 3/08; B08B 9/093; B08B 5/04; B08B 3/02

(52) U.S. Cl. CPC B08B 3/08; B08B 3/02; B08B 9/093; B08B 5/04
USPC 134/21; 134/28; 134/22.1; 134/34

(57) ABSTRACT

According to one embodiment, a wafer carrier cleaning method is provided. The wafer carrier cleaning method includes cleaning a wafer carrier with a chemical solution containing a weak acid that can dissolve metals, and cleaning the wafer carrier cleaned with the chemical solution, with pure water. The weak acid contained in the chemical solution is preferably citric acid that can dissolve heavy metals and does not damage the wafer carrier.

### CROSS-REFERENCE TO RELATED APPLICATION

This application is based upon and claims the benefit of priority from Japanese Patent Application No. 2013-173913, filed Aug. 23, 2013, the entire contents of which are incorporated herein by reference.

### FIELD

Embodiments described herein relate to a wafer carrier cleaning method.

### BACKGROUND

Wafers used for forming semiconductor devices are conventionally held in wafer carriers such as front opening unified pods (FOUPs), for example, for transportation from one processing apparatus to a different processing apparatus. The wafer carriers have supports such as shelves or slots therein for supporting the wafers.

When the wafers are placed in the wafer carriers having contaminants adhering to the supports thereof, the contaminants may be transferred from the support to the wafer(s). In this case, the contaminants transferred to the wafers can cause degradation in the properties of the semiconductor devices formed on or in the wafer.

Accordingly, it is common to periodically clean wafer carriers with pure water. However, it can be difficult to sufficiently clean contaminants off the inner surfaces of the carrier by cleaning with only pure water.

### DESCRIPTION OF THE DRAWINGS

FIG. 1 is a schematic perspective view of a FOUP according to an embodiment.

FIG. 2 is a schematic horizontal cross-sectional view of the FOUP according to the embodiment.

FIG. 3 is a flowchart showing a wafer carrier cleaning process according to the embodiment.

FIG. 4 is a plan view schematically showing a cleaning apparatus according to the embodiment.

FIG. 5A is an explanatory diagram showing a cleaning operation of a cleaning device according to the embodiment.

FIG. 5B is an explanatory diagram showing a cleaning operation of the cleaning device according to the embodiment.

FIG. 5C is an explanatory diagram showing a cleaning operation of the cleaning device according to the embodiment.

FIG. 6 is an explanatory diagram showing a reduced-pressure degassing operation of a decompressor according to the embodiment.

### DETAILED DESCRIPTION

In general, according to one embodiment, it is an object to provide a wafer carrier cleaning method in which the cleaning capability can be enhanced as compared with a cleaning method using pure water. In the embodiments described herein, pure water is de-ionized water.

In general, according to one embodiment, a wafer carrier cleaning method is provided. The wafer carrier cleaning method includes cleaning a wafer carrier with a chemical solution containing a weak acid that can dissolve metals, and then cleaning the wafer carrier cleaned with the chemical solution with pure water.

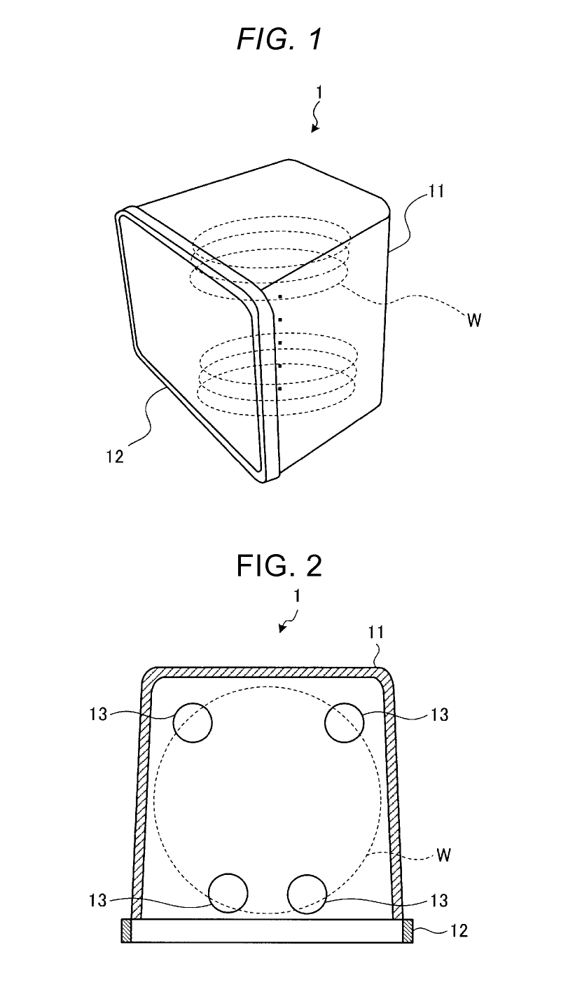

Hereinafter with reference to the accompanying drawings, a wafer carrier cleaning method according to an embodiment will be described in detail. The invention is not particularly limited to the exemplary embodiment. First, with reference to FIGS. 1 and 2, a wafer carrier to be cleaned according to the embodiment will be described.

Here, description will be made of a case where an object of cleaning is a front opening unified pod, commonly referred to as a FOUP. A FOUP is a wafer carrier for holding semiconductor wafers (hereinafter, referred to merely as “wafers”) to be transported from one wafer processing apparatus to a different wafer processing apparatus. Objects of cleaning according to the embodiment are not limited to FOUPs, and may be other wafer carriers such as front opening shipping boxes, also known as FOSBs.

FIG. 1 is a schematic perspective view of a FOUP according to the embodiment. FIG. 1 shows the FOUP placed on a horizontal plane. FIG. 2 is a schematic horizontal cross-sectional view of the FOUP according to the embodiment.

As shown in FIG. 1, a FOUP 1 has a carrier body 11 capable of holding a plurality of (for example, 25) wafers W inside, and a detachable cover 12 for closing the front opening of the carrier body 11. The carrier body 11 has a plurality of aligned supports on which individual wafers are supported.

As shown in FIG. 2, each plurality of aligned supports includes individual supports 13 for supporting the peripheral edge (bevel) of a wafer W at a plurality of points (here, at four points). During processing semiconductor wafers with the FOUP 1, contaminants can adhere to the supports 13.

Contaminants adhering to the supports 13 can thereafter be transferred to a wafer W held in the FOUP 1, adversely affecting the properties of semiconductor devices formed on that wafer W. Further, contaminants adhering to regions other than the supports 13 in the FOUP 1 can be freed by an air current or the like, and then adhere to the wafer W, and ultimately adversely affect the properties of the semiconductor devices formed thereon.

In a case where solid-state imaging devices are formed on the wafer W, for example, when heavy-metal contaminants existing in the FOUP 1 adhere to the wafer W, the contaminants cause dark current to be generated in the solid-state imaging devices and the dark current causes a white flaw to appear on an image. The heavy-metal contaminants, which are one of the causes of white flaws, are difficult to remove from the FOUP 1 simply by cleaning with the FOUP 1 with pure water.

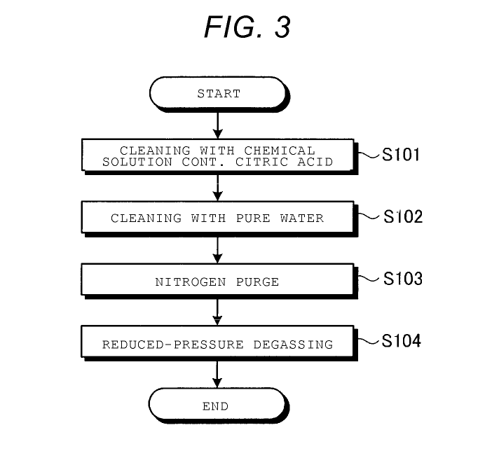

Next, with reference to FIG. 3, a wafer carrier cleaning method which enables washing and removal of the contaminants from the FOUP 1 will be described. FIG. 3 is a flowchart showing a wafer carrier cleaning process according to the embodiment.

As shown in FIG. 3, in the wafer carrier cleaning method according to the embodiment, first, the FOUP 1 is subjected to cleaning with a chemical solution containing citric acid (step S101). The chemical solution used here is made by adding a surfactant and a chelating agent to a 28-31 percent citric acid solution which is diluted about thirty times with water.

The citric acid contained in the chemical solution has the property of dissolving heavy metals such as platinum, gold, mercury, silver, lead, copper, chromium, manganese, cobalt, and nickel, for example. Further, citric acid, even though is used in the form of stock solution, does not significantly degrade or dissolve resins such as polycarbonate and fluororesin mainly used as the material of the FOUP 1.

Thus, by cleaning the FOUP 1 with the chemical solution containing the citric acid, heavy-metal contaminants adhering to the FOUP 1 can be dissolved to be washed and removed. Further, the cleaning with the chemical solution containing the citric acid hardly causes degradation and dissolution of the FOUP 1 itself, thus being able to extend the useful life of the FOUP 1. Moreover, the chemical solution containing the citric acid used in the embodiment has nonvolatility in an atmosphere at normal atmospheric pressure, i.e., at or around 760 torr, and at 100° C. or lower temperatures.

Next, the FOUP 1 is subjected to cleaning with pure water (step S102). With this, contaminants other than heavy metals including organic substances such as photoresists, silicon oxide, and silicon nitride that were not sufficiently removed with the chemical solution containing the citric acid are washed and removed.

Subsequently, the FOUP 1 is subjected to a nitrogen purge (step S103). Here, a heated nitrogen gas is sprayed on the FOUP 1, thereby blowing drops of water off the interior surfaces and drying the FOUP 1.

Finally, the FOUP 1 is subjected to reduced-pressure degassing (step S104), which completes the process. In the reduced-pressure degassing step, by exposing the FOUP 1 in an almost-vacuum reduced-pressure atmosphere environment, chemical solutions permeating into a surface layer portion of the FOUP 1 are gasified and removed from the FOUP 1.

Thus, in the wafer carrier cleaning method according to the embodiment, before cleaning with pure water, the FOUP 1 is cleaned by a chemical solution containing citric acid that is a weak acid capable of dissolving metals. With this, metal contaminants can be washed and removed from the FOUP 1.

Consequently, according to the wafer carrier cleaning method, when the FOUP 1 holding wafers W on which solid-state imaging devices are formed is cleaned, for example, transfer from the FOUP 1 to the wafers W of metal contaminants to be a cause of dark current in solid-state imaging devices can be prevented.

Further, as described above, the chemical solution containing the citric acid used in the embodiment has nonvolatility in an atmosphere at atmospheric pressure and at 100° C. or less. Typically, the FOUP 1 is not exposed to an environment at 100° C. or higher during transportation between processing apparatuses.

Therefore, by the wafer carrier cleaning method according to the embodiment, even when the chemical solution cannot be completely gasified and removed from the FOUP 1 by the reduced-pressure degassing, the chemical solution does not gasify from the FOUP 1 when the FOUP 1 is in use. Thus, adversely affecting wafers and human bodies due to gas of the chemical solution gasifying from the FOUP 1 when the FOUP 1 is in use can be prevented.

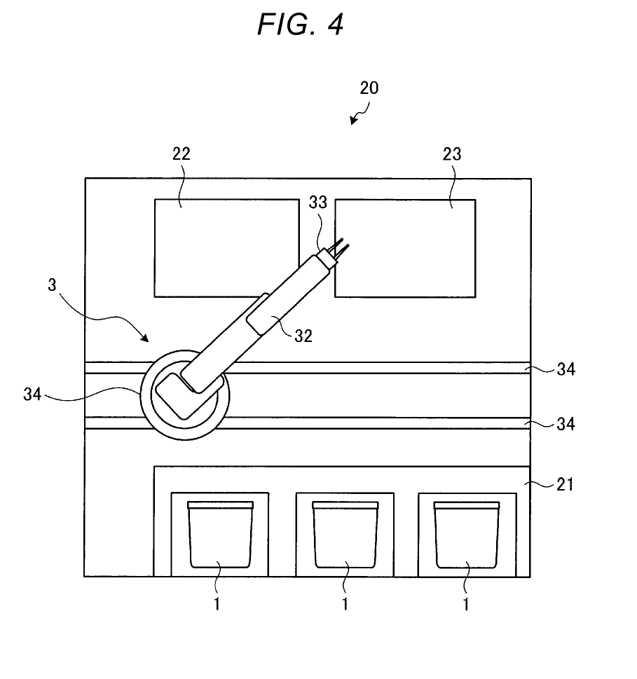

Next, with reference to FIG. 4, a wafer carrier cleaning apparatus 20 according to the embodiment will be described. FIG. 4 is a plan view schematically showing the cleaning apparatus 20 according to the embodiment. As shown in FIG. 4, the cleaning apparatus 20 includes a stage 21 on which a plurality of FOUPs 1 can be placed, a cleaning device 22 for cleaning the FOUPs 1, and a decompressor 23 for performing reduced-pressure degassing on the FOUPs 1 after cleaning.

Further, the cleaning apparatus 20 includes a robot 3 for transporting the FOUPs 1 between the stage 21, the cleaning device 22, and the decompressor 23. The robot 3 has a base 34 rotatable with a vertical axis as the axis of rotation, a robot arm 32 with a plurality of joints extending from the base 34, and an end effector 33 provided at the distal end of the robot arm 32 and capable of grasping the FOUP 1.

Travelling along rails 34 in a cleaning chamber, the robot 3 takes out an unclean FOUP 1 from the stage 21, places it in the cleaning device 22, takes out the FOUP 1 after cleaning from the cleaning device 22, and places it in the decompressor 23. Thereafter, the robot 3 takes out the FOUP 1 after reduced-pressure degassing, and returns it to the stage 21.

The robot 3, the stage 21, the cleaning device 22, and the decompressor 23 are provided in a cleaning chamber that is airtight and hermetically closed. The cleaning apparatus 20 can prevent harmful substances generated during cleaning of the FOUPs 1 from adversely affecting an operator.

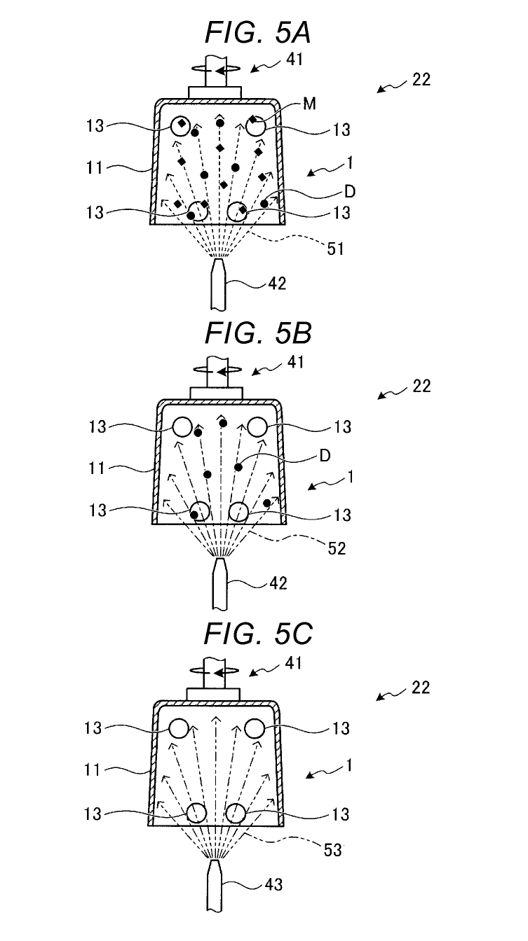

Next, with reference to FIGS. 5A, 5B, and 5C, cleaning operations performed by the cleaning device 22 will be described. FIGS. 5A, 5B, and 5C are explanatory diagrams showing the cleaning operations of the cleaning device 22 according to the embodiment. Further, FIGS. 5A, 5B, and 5C show the carrier body 11 in cross-section in order to facilitate understanding the cleaning operations.

Here, the operations of cleaning the carrier body 11 by the cleaning device 22 are described. The cover 12 is cleaned like the carrier body 11 by a different cleaning device not shown provided in the cleaning chamber.

As shown in FIG. 5A, the cleaning device 22 has a rotary holder 41 for rotatably holding the back of the FOUP 1 vertically from above, and a nozzle 42 arranged below the rotary holder 41 to be opposite to the rotary holder 41.

When cleaning by the cleaning device 22 is performed, the robot 3 places the carrier body 11 for connection to the rotary holder 41, the carrier body 11 having metal contaminants M and contaminants D other than metal adhered thereto. At this time, the robot 3 positions the back of the carrier body 11 held by the rotary holder 41 such that the front opening side of the carrier body 11 faces downward. Thus, the metal contaminants M and the contaminants D other than metals washed from the walls of the carrier body 11 are removed and fall onto the bottom of the cleaning device 22, thus being prevented from adhering again to the carrier body 11.

When the carrier body 11 is placed therein, the cleaning device 22, while rotating the carrier body 11 with the rotary holder 41, sprays a chemical solution 51 containing citric acid from the nozzle 42 into the carrier body 11 to wash and remove the metal contaminants M.

Next, as shown in FIG. 5B, while rotating the carrier body 11 with the rotary holder 41, the cleaning device 22 sprays pure water 52 from the nozzle 42 into the carrier body 11 from which the metal contaminants M were washed and removed to wash and remove the contaminants D other than metals from the carrier body. Further, in this step, the chemical solution 51 containing the citric acid is also washed and removed from the carrier body 11.

Thereafter, as shown in FIG. 5C, while rotating the carrier body 11 with the rotary holder 41, the cleaning device 22 sprays a heated nitrogen gas 53 from the nozzle 42 into the carrier body 11 from which the contaminants D other than metal were washed and removed. This spraying blows off drops of water from the carrier body 11, and dries the carrier body 11.

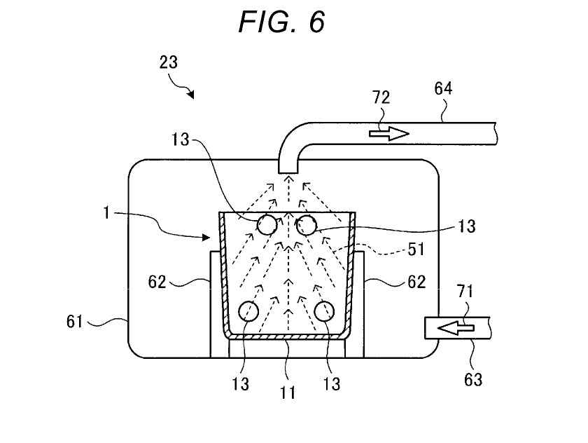

Next, with reference to FIG. 6, a reduced-pressure degassing operation performed by the decompressor 23 will be described. FIG. 6 is an explanatory view showing the reduced-pressure degassing operation of the decompressor 23 according to the embodiment. FIG. 6 shows the carrier body 11 in cross-section in order to facilitate understanding of the reduced-pressure degassing operation.

Here, the reduced-pressure degassing of the carrier body 11 by the decompressor 23 will be described. The lid 12 is subjected to reduced-pressure degassing like the carrier body 11 by a different decompressor (not shown) provided in the cleaning chamber.

As shown in FIG. 6, the decompressor 23 has a chamber 61 constituting a hermetically-closed space, and holders 62 for holding the carrier body 11 in the chamber 61. Further, the decompressor 23 has an air supply pipe 63 for supplying clean air 71 into the chamber 61, and an exhaust pipe 64 for sucking and discharging an internal atmosphere 72 in the chamber 61 to the outside. A supply device (not shown) for supplying the air 71 is connected to the air supply pipe 63, and a vacuum pump (not shown) is connected to the exhaust pipe 64.

When reduced-pressure degassing by the decompressor 23 is performed, the robot 3 places the carrier body 11 after cleaning and drying on the holders 62. At this time, the robot 3 places the carrier body 11 on the holders 62 so that the front opening side of the carrier body 11 faces vertically upward. With this, the chemical solution 51 gasified by the reduced-pressure degassing can be prevented from staying in the chamber 61 and adhering again to the carrier body 11.

When the carrier body 11 is placed therein, the decompressor 23 sucks out the internal atmosphere 72 in the chamber 61 by the vacuum pump through the exhaust pipe 64 while supplying the air 71 from the supply device through the air supply pipe 63 into the chamber 61. The decompressor is able to maintain the chamber 61 at below atmospheric (ambient) pressure, and thus contaminants, residual cleaning materials and other materials such as gasses which were adsorbed on or in the surface of the carrier are liberated from the surface of the carrier, and then pumped away from the area around the carrier through the exhaust pipe 64.

At this time, the vacuum pump sucks out a larger quantity of the internal atmosphere 72 of the decompressor in a unit time than the quantity of air 71 supplied by the supply device in the unit time, thereby reducing the pressure in the decompressor 23 to make the interior of the chamber 61 almost vacuum. Thus, the chemical solution 51 containing the citric acid not gasifying at normal temperatures permeating into the inner surface of the carrier body 11 can be volatilized to be released to the outside of the carrier body 11, commonly known as degassing, and the volatiles discharged through the exhaust pipe 64 to the outside of the chamber 61.

Thus, the decompressor 23 can remove even the chemical solution 51 permeating into the inner surface of the carrier body 11 almost completely from the carrier body 11. Further, as described above, since the chemical solution 51 used in the embodiment has non-volatility in an atmosphere at normal atmospheric pressure of around 760 torr and at 100° C. or lower, even when the chemical solution 51 remains in minute amounts on the carrier body 11 after reduced-pressure degassing, the remaining chemical solution 51 does not gasify from the FOUP 1 in use.

As described above, in the wafer carrier cleaning method according to the embodiment, a wafer carrier is cleaned with a chemical solution containing a weak acid capable of dissolving metals, and then the wafer carrier after cleaning with the chemical solution is cleaned with pure water.

By the wafer carrier cleaning method according to the embodiment, metal contaminants that are difficult to sufficiently wash and remove by cleaning with pure water can be washed and removed from a wafer carrier, so that the cleaning capacity can be enhanced as compared with cleaning using pure water.

Specifically, an experiment was performed on a wafer carrier used for thirty days, in which the amount of metal contaminants adhering to the wafer carrier was measured before and after cleaning by the wafer carrier cleaning method according to the embodiment. An inductively coupled plasma mass spectrometer (ICP-MS) was used for the measurement of the amount of contaminants.

The results of the experiment show that the amount of metal contaminants was about 1E+10 atoms/cm² before cleaning by the wafer carrier cleaning method according to the embodiment, and it was reduced to about 1E+8 atoms/cm² after cleaning. That is, it was verified that by the wafer carrier cleaning method according to the embodiment, the amount of metal contaminants is reduced to 1/10 to 1/100 of that before cleaning.

Further, since a chemical solution used in cleaning by the wafer carrier cleaning method according to the embodiment is weak acid, metal contaminants can be cleaned while degradation and dissolution of wafer carriers are prevented. Thus the useful lifetime of the wafer carriers can be extended.

Moreover, a weak acid in a chemical solution used in the wafer carrier cleaning method according to the embodiment is a chemical solution capable of dissolving heavy metals. By cleaning, with the solution, wafer carriers used for transportation of wafers on which solid-state imaging devices are formed, heavy metals which are a cause of dark current causing white flaws in the solid-state imaging devices can be washed and removed from the wafer carriers.

Furthermore, as a weak acid in a chemical solution used in the wafer carrier cleaning method according to the embodiment, citric acid can be used. Citric acid is relatively readily available, can dissolve heavy metals, and does not degrade and dissolve wafer carriers, even though is used in the form of stock solution.

Such a chemical solution for cleaning containing citric acid is also used as a cleaning agent for maintenance that removes metallic impurities adhering to chemical mechanical polishing (CMP) apparatuses, for example. Therefore, by the wafer carrier cleaning method according to the embodiment, it is not necessary to prepare a special chemical solution for cleaning wafer carriers, and a cleaning agent for maintenance in CMP may be used.

Although the embodiment has been described on the case where the weak acid in the chemical solution is citric acid, the weak acid contained in the chemical solution may be any other weak acid that is a weak acid having a pH near to that of citric acid and can dissolve metals.

Although the embodiment has been described on the case where a chemical solution containing citric acid is sprayed on wafer carriers to wash and remove metal contaminants, wafer carriers may be immersed into a chemical solution containing citric acid to wash and remove metal contaminants.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wafer carrier cleaning method, comprising:
cleaning a wafer carrier with a chemical solution containing a weak acid that can dissolve metals; and
cleaning the wafer carrier cleaned with the chemical solution, with pure water.

2. The method according to claim 1, wherein the weak acid is an acid capable of dissolving heavy metals.

3. The method according to claim 1, wherein the weak acid is citric acid.

4. The method according to claim 1, wherein the chemical solution is nonvolatile at atmospheric pressure and at temperatures of 100° C. or less.

5. The method according to claim 1, wherein the wafer carrier is a container for holding wafers on which solid-state imaging devices are formed.

6. The method according to claim 1, further comprising:
subjecting the cleaned wafer carrier to a sub-atmospheric environment having gas flowing therethrough.

7. The method according to claim 1, wherein the chemical solution does not dissolve non-metal portions of the interior surfaces of the wafer carrier.

8. The method according to claim 7, wherein a robot moves the wafer carrier to a first station for cleaning the wafer carrier with a chemical solution containing a weak acid that can dissolve metals and for rinsing the wafer carrier cleaned with the chemical solution, with pure water.

9. The method according to claim 8, wherein the robot further moves the wafer carrier from the first station to a second station, for sub-atmospheric degassing of the carrier.

10. The method according to claim 9, wherein the degassing of the wafer carrier occurs in a flow of nitrogen gas.

11. The method according to claim 9, wherein the wafer carrier has an opening on a side thereof, and the wafer carrier is processed with its open side down in the first station, and its open side up in the second station.

12. The method according to claim 8, wherein the first station includes a rotatable holder, and the robot positions the wafer carrier for securement thereof to the rotary holder.

13. A method of cleaning interior surfaces of a wafer carrier comprising an interior volume and an opening to the interior volume, said method comprising:
spraying the interior surfaces of the wafer carrier with a chemical solution containing a weak acid that can dissolve metals located at the interior surfaces of the wafer carrier; and then
spraying the interior surfaces of the wafer carrier with pure water.

14. The method of claim 13, further comprising:
after spraying the interior surfaces of the wafer carrier with the chemical solution and then the pure water, exposing the interior surfaces of the wafer carrier to a vacuum.

15. The method of claim 13, wherein the wafer carrier has a body that is inert to the weak acid.

16. The method of claim 14, wherein the interior surfaces of the wafer carrier that have been exposed to vacuum after spraying the interior surfaces of the wafer carrier with the chemical solution and then the pure water, have a lower metal contaminant level, by an order of 10 to 100 times, than interior surfaces of a wafer carrier that has not been exposed to vacuum after spraying the interior surfaces of the wafer carrier with the chemical solution and then the pure water.

17. A method of cleaning a wafer carrier, comprising:
positioning a wafer carrier over a spray head with an open end of the wafer carrier facing down, and spraying a weak acid solution at interior surfaces of the wafer carrier; and then
maintaining the wafer carrier in position over the spray head and spraying pure water at the interior surfaces of the wafer carrier.

18. The method of claim 17, further comprising:
positioning the wafer carrier below a suction pipe with the open end of the wafer carrier facing the suction pipe, and removing residual material adhering to the interior surfaces of the wafer carrier using the suction pipe.

19. The method of claim 18, further comprising:
rotating the wafer carrier while spraying the weak acid solution and the pure water at the interior surfaces of the wafer carrier.

20. The method of claim 19, wherein the wafer carrier is stationary and the open end of the carrier is facing up when the residual material adhering to the interior surfaces of the wafer carrier is removed using the suction pipe.
